(19) United States
(12) Patent Application Publication
(10) Pub. No.: US 2020/0268595 A1
(43) Pub. Date: Aug. 27, 2020

(54) STIMULATION DEVICE

(71) Applicant: ESEYE LIMITED, Guildford (GB)

(72) Inventors: Adam LEWIS, London (GB); Julia MARGO, London (GB)

(21) Appl. No.: 16/789,717

(22) Filed: Feb. 13, 2020

(30) Foreign Application Priority Data
Feb. 14, 2019 (GB) 1902069.2

(51) Int. Cl. A61H 19/00; A61H 23/02

(52) U.S. Cl. CPC A61H 19/30; A61H 2023/0272; A61H 23/0263

(57) ABSTRACT

Presented is a device for stimulating the frenulum of the male genitalia. The device comprises a vibratory part configured to generate vibrations and attachment means configured to hold the vibratory part in place against the frenulum during use so as to apply generated vibrations to the frenulum. The vibratory part is configured to simultaneously generate vibrations of a first and second different frequency

### CROSS-REFERENCE TO RELATED APPLICATIONS

The present application claims priority under 35 U.S.C. § 119 to British Patent Application No. 1902069.2, filed Feb. 14, 2019, which is hereby incorporated by reference in its entirety.

### FIELD

The present disclosure relates to a device which provides stimulation of the male genitalia. More specifically, the disclosure relates to a device, which when attached to the penis, is adapted to deliver vibrations to the frenulum.

### BACKGROUND

There are a wide variety of devices which are already available which seek to stimulate the male genitalia through a variety of means, either for medical purposes, such as sperm collection or to assist those suffering from erectile dysfunction, or simply for pleasure.

A large range of products has been developed and marketed with a recreational purpose, what are commonly referred to as sex-toys. These devices seek to stimulate the male genitalia in order to give pleasure. In these circumstances, an important aim of these devices is stimulation and arousal. Often postponing the orgasm is desirable. Various different means of stimulation have been proposed in the past, offering the man varying degrees of control and requiring different levels of intervention and action by the man.

The male sex toy market is extensive but lacks variety. Despite the fact that it is known that vibrations applied to the penis can cause arousal and result in orgasm and ejaculation, there are relatively few products which are actually designed to stimulate the penis through vibrations. The majority of male sex toys are ‘sleeves’ which fit over the penis and are moved by hand.

Some products do work by applying vibration, but these often fail to offer the optimum vibrations.

Products designed to be hands-free do not offer optimum vibratory amplitude and are not adjustable. They are also designed to fit around the base of the penis, neglecting the frenulum. Vibrating cock rings are also invariably designed to fit around the base of the penis.

The frenulum is the most sensitive area of the penis and it has been found that vibrations applied to this small area of the penis are very effective in causing arousal and orgasm.

Medical research has identified the required vibratory amplitude and frequency for stimulating the penis. The study reported by N. L. Brackett in Human Reproduction Update (1999) Vol. 5, No. 5, p 551-552 discusses the use of different amplitude and frequency of vibration in order to produce ejaculation in patients with spinal cord injury. The results suggested that vibration having a frequency of about 100 Hz and an amplitude of about 2.5 mm is suitable for causing ejaculation in patient with spinal cord injuries. The study showed that both high and low amplitude vibrations were successful in causing ejaculation, frequently within just two minutes. This is useful in a medical setting, such as the study in question, but does not represent an optimum result for a device which is designed for recreational use.

Evidence suggests that the optimum amplitude and frequency of vibration for the purpose of pleasure varies from person to person and may also vary during use of the device.

### SUMMARY

According to a first aspect of the present disclosure, there is provided a device for stimulating the frenulum of the male genitalia, the device comprising: a vibratory part configured to generate vibrations; and attachment means configured to hold the vibratory part in place against the frenulum during use so as to apply generated vibrations to the frenulum, wherein the vibratory part comprises first and second vibration means configured to simultaneously generate vibrations of a first and second frequency, respectively, and wherein the first frequency is different from the second frequency.

The attachment means may comprise a ring that is shaped and sized to receive the penis.

The attachment means may be made from a malleable material which transmits vibrations.

The attachment means may comprise a ring or sleeve that is shaped and sized to receive the penis.

The vibratory part may comprise a motor, and preferably the motor may be configured to generate vibrations of variable frequency and/or amplitude.

The first vibration means may comprise a first gearing arrangement adapted to translate rotation of the rotor of the motor into vibrations of the first frequency, and the second vibration means may comprise a second gearing arrangement adapted to translate rotation of the rotor of the motor into vibrations of the second frequency.

Alternatively, the first vibration means may comprise a first motor configured to generate vibrations of the first frequency, and the second vibration means may comprise a second motor configured to generate vibrations of the second frequency. For example, the first vibration means may comprise an eccentric weight mounted to a rotatable shaft of the first motor, and the second vibration means may comprise an eccentric weight mounted to a rotatable shaft of the first second motor. Further, the eccentric weight of the first vibration means may be of larger mass than the eccentric weight of the second vibration means.

At least one of the first and second motors may be configured to generate vibrations of variable frequency and/or amplitude.

The attachment means may be configured to releasably hold the vibratory part so that the vibratory part is removable from the attachment means (e.g. to facilitate easy cleaning and/or replacement).

Some embodiments may further comprise a control unit configured to control the vibratory part to adjust the first and second frequency.

In an embodiment, the first vibration means may be configured to generate vibrations of a first frequency within a first range of frequencies, and the second vibration means may be configured to generate vibrations of a second frequency within a second, different range of frequencies.

The first frequency may be within the range of 2 kilohertz (kHz)-7 kHz and the second frequency may be within the range of 2 kHz-90 kHz.

The amplitude of the generated vibrations may be preferably up to 3 mm, and more preferably up to 2.5 mm.

The device may be battery operated.

According to another aspect of the disclosure, there is provided a method for stimulating the frenulum of the male genitalia, the method comprising: simultaneously generating vibrations of a first and second frequency with a vibratory part, wherein the first frequency is different from the second frequency; and holding the vibratory part in place against the frenulum during so as to apply generated vibrations to the frenulum.

Thus, there may be provided a method for stimulating the frenulum of the male genitalia for pleasure, the method comprising using a device according to a proposed embodiment.

Proposed embodiments may provide a lightweight device, which when attached to the penis, delivers vibrations of two different frequencies simultaneously to the frenulum

Embodiments may have the following attributes:
Hands-free
Can be used when the penis is still flaccid
Adapted to stimulate the frenulum
Provide adjustable amplitude and frequency
Battery powered, so cheap to maintain
Compact and lightweight so easily transported.
Adapted to permit removal of the vibratory part so as to facilitate cleaning.

Embodiments may provide a device for stimulating the frenulum of the male genitalia. The device may comprise a vibratory part configured to generate vibrations and attachment means configured to hold the vibratory part in place against the frenulum during use so as to apply generated vibrations to the frenulum. The vibratory part may simultaneously generate vibrations of a first and second different frequency.

### BRIEF DESCRIPTION OF THE DRAWINGS

FIG. 1 is a simplified illustration of a device according to an embodiment, wherein the device is in an “ON” state in which it is simultaneously generating vibrations of a first and second frequency;

FIG. 2 depicts the device of FIG. 1 in use on a user's penis;

FIG. 3 illustrates a system for controlling the device of FIG. 1 to vary the first and second frequencies; and

FIG. 4 illustrates how a device according to an embodiment may be controlled to modify a pattern of generated vibrations.

### DETAILED DESCRIPTION

The disclosure will be described with reference to the Figures. It should be understood that the detailed description and specific examples, while indicating exemplary embodiments of the apparatus, systems and methods, are intended for purposes of illustration only and are not intended to limit the scope of the disclosure. These and other features, aspects, and advantages of the apparatus, systems and methods of the present disclosure will become better understood from the following description, appended claims, and accompanying drawings. It should be understood that the Figures are merely schematic and are not drawn to scale. It should also be understood that the same reference numerals are used throughout the Figures to indicate the same or similar parts.

The present disclosure relates to a simple and easy to use stimulatory device which can deliver vibrations to the frenulum of the penis at two different frequencies simultaneously. Put another way, the device may generate vibrations at two substantially different frequencies at the same time, and the vibrations of two differing frequencies may be delivered to the frenulum of a user at the same time (i.e. concurrently or simultaneously). For instance, an embodiment may be configured to deliver low frequency vibrations and high frequency vibrations to the frenulum of the penis at the same time. This may provide for improved user experience.

By way of example, a proposed embodiment may be configured to provide two different stimulation frequencies simultaneously. Preferably, this may be done using two motors that may be controlled independently. For instance, a first motor may be configured to generate vibrations in a low frequency range (e.g. 2 kHz-7 kHz), and a second motor may be configured to generate vibration in a medium or high frequency range (e.g. 7 kHz-90 kHz).

The device may be a hands-free device, so that a user does not have to manually hold or manipulate the device during use. For example, some embodiments of the device are intended to provide a hands-free device and be attached to the penis during use. The size and weight of the part of the device which is held against the frenulum is therefore preferably small and lightweight. Ideally, the attachment means are adapted to soft and/or malleable and of minimum weight and/or structural integrity to securely hold the vibrating part in place and transmit vibrations to the frenulum in use. However, it may be preferable to ensure that the attachments means are not be so small or lightweight that any small movement during use could render it less effective due to poor positioning.

The attachment means may be preferably formed from a material which has one or more of the following properties, and most preferably all of them: easy to clean; hypoallergenic; not heat conducting; high elasticity; and high malleability. For example, in one embodiment, the attachment means may be a plastic material. In an alternative embodiment, the attachment means may be made from a more malleable or pliable material, such as a gel, which transmits vibrations but which is also soft and may shape itself, to an extent, to the shape of the surface of the penis. Suitable materials will be well-known to a skilled person.

The vibrations may be produced by one or more motors. Such a motor employed by embodiments may preferably be small and lightweight. It may also be preferable for such a motor to be capable of producing vibrations of variable frequency and amplitude. A low frequency of vibrations produced by the vibration part may preferably by up to 7 kHz, whereas a high frequency of vibrations produced by the vibration part may preferably be over 7 kHz (preferably up to 150 kHz, and more preferably up to 90 kHz). The amplitude of the vibrations produced by the vibration part may be preferably up to 3 mm, and more preferably up to 2.5 mm.

The vibration part may be controlled by a control panel (or control unit), allowing the user to adjust the first and second frequencies. In some embodiments, the control panel may also be configured to allow the user to adjust an amplitude of the vibrations and/or a pattern of the vibrations. Preferably, the control panel may be separate from the vibrating part and configured to facilitate easy access/use whilst the device is in use. In a preferred embodiment, the control panel is attached to the vibrating part by a wire which allows the control panel to be conveniently located during use of the device. In an alternative embodiment, the control panel may be totally detached from the vibrating part (e.g. wirelessly connected to the vibrating part), providing “remote control” of the device.

The device of the disclosure is preferably battery operated, although it could be mains powered or rechargeable. The battery is preferably located away from the motor and the vibrating surface, so as to minimise the size and weight of the part of the device to be attached to the penis. In one embodiment, the battery is connected to the motor by a wire, optionally as part of the control panel.

It would be particularly convenient for the battery to be a rechargeable battery, with the device having a charger or a charging station to allow it to be charged between uses.

For a fuller understanding of the proposed concepts, reference is now made to the accompanying drawings, which are intended to illustrate exemplary embodiments described and claimed herein and is not intended to be limiting.

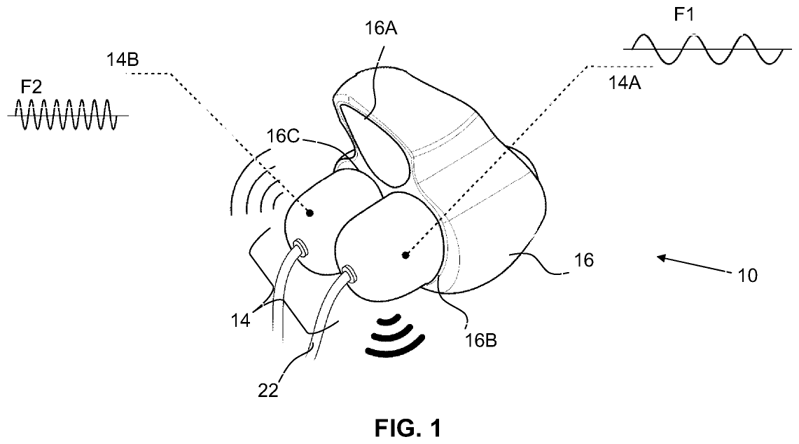

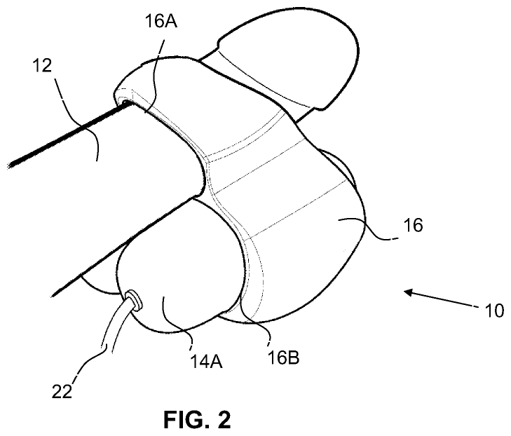

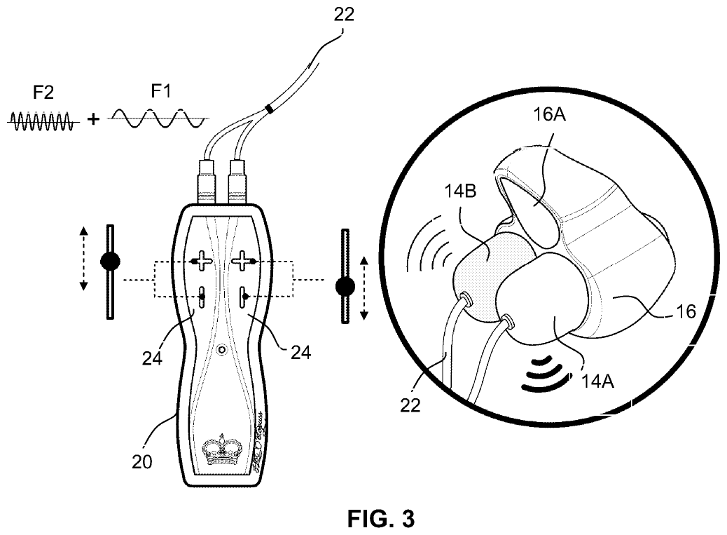

Referring now to FIGS. 1-3, there is depicted a device 10 according to an embodiment. Specifically, FIG. 1 illustrates the device 10 in an “ON” state wherein it is generating vibrations of a first and second frequency simultaneously. FIG. 2 depicts the device in use on a user's penis. FIG. 3 illustrates how the device 10 may be controlled to vary the first and second frequencies.

The device 10 is configured for stimulating the frenulum of the male genitalia 12. The device 10 comprises: a vibratory part 14 configured to generate vibrations, and attachment means 16 configured to hold the vibratory part 14 in place against the frenulum during use so as to apply generated vibrations to the frenulum.

The vibratory part 14 comprises first 14A and second 14B vibration means configured to simultaneously generate vibrations of a first F1 and second F2 frequency, respectively. The first frequency F1 is different from the second frequency F2.

The first vibration means 14A are configured to generate vibrations of a first frequency F1 within a first range of frequencies, and the second vibration means 14B are configured to generate vibrations of a second frequency F2 within a second, different range of frequencies. In this exemplary embodiment, the first frequency F1 is within the range of 2-7 kHZ (and may be referred to as a ‘low frequency’). Further, the second frequency F2 is within the range of 7-90 kHz (and may be referred to as a ‘high frequency’).

In this exemplary embodiment, the first vibration means 14A comprise a first motor (having an eccentric weight mounted to a rotatable shaft) that is configured to generate vibrations of the first frequency F1. Further, the second vibration means comprise a second motor (having an eccentric weight mounted to a rotatable shaft) configured to generate vibrations of the second frequency F2.

The eccentric weight of the first vibration means 14A is larger in size and mass than the eccentric weight of the second vibration means 14B. In this way, the larger/heavier weight employed by the first vibration means 14A assists in making the vibrations generated by the first vibration means 14A have lower frequency than those generated by the second vibration means 14B (which employs a smaller/lighter mass).

Purely by way of example, in this embodiment, the eccentric weight of the first motor is 8.0×10.8 mm, whereas the eccentric weight of the second motor is 7.0×7.2 mm.

The attachment means 16 comprises three rings (or tubes or sleeves) that are connected together to be adjacent each other. The central axes of the three rings (or tubes) are spaced apart and substantially parallel with each other. The attachment means 16 are made from a soft and/or malleable material which transmits vibrations.

The first ring 16A of the attachment means 16 is shaped and sized to receive the male genitalia 12 (as illustrated in FIG. 2).

The second 16B and third 16C rings of the attachment means 16 are shaped and sized to receive the first 14A and second 14B vibration means, respectively. Here, it is noted that the second 16B and third 16C rings are configured to releasably hold the first 14A and second 14B vibration means so that the first 14A and second 14B vibration means are removable from the attachment means 16 (e.g. to facilitate easy cleaning and/or changing/replacement of the attachment means or vibration means).

The device 10 of this exemplary embodiment also comprises a control unit 20 that is configured to control the vibratory part 14 so as to adjust the first F1 and second F2 frequencies. The control unit 20 is attached to the vibrating part by a wire 22 which allows the control panel to be conveniently located during use of the device 10. In an alternative embodiment, the control panel may be totally detached from the vibrating part (e.g. wirelessly connected to the vibrating part), providing “remote control” of the device.

The control unit 20 houses one or more power sources (e.g. batteries) for supplying power to the vibratory part (e.g. via the wire 22). In this way, the combined weight of the vibratory part and attachments means may be minimised (e.g. by not including the power source).

The control unit 20 comprise a user interface for receiving user inputs for controlling the vibratory part. Here, the user interface is configured to enable independent/separate control of the first 14A and second 14B vibration means. In other words, the user interface of the control unit 20 enables the frequency and/or amplitude of the vibrations generated by first 14A and second 14B vibration means to be controlled (e.g. modified, altered or changed) separately from each other.

Although the embodiment described above has been detailed as employing first and second motors, it is envisaged that other embodiments may employ different first and second vibration means. By way of example, alternative embodiments may only employ a single motor. The first vibration means may then comprise a first gearing arrangement that is adapted to translate rotation of the rotor (or rotating shaft) of the motor into vibrations of the first frequency. Further, the second vibration may means comprise a second gearing arrangement that is adapted to translate rotation of the rotor (or rotating shaft) of the motor into vibrations of the second frequency.

Other arrangements that are adapted to generate vibrations of two differing frequencies simultaneously are envisaged and considered to be within the general knowledge and/or skill of a skilled person in the field of engineering.

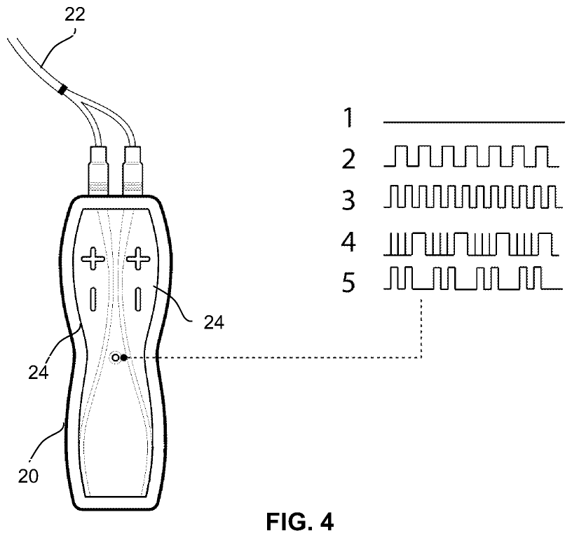

Other modifications or variations to the embodiments described above are envisaged. For example, referring to FIG. 4, the control unit 20 comprises a user interface for receiving user inputs for controlling the vibratory part. Here, the user interface is configured to also enable a pattern of generated vibrations to be controlled. As depicted by the illustrated power signals (labelled “1” to “5”) supplied to the vibratory part, the control unit 20 may be adapted to switch vibrations on or off in various different patterns. This may offer a personalised and varied usage experience to a user.

Variations to the disclosed embodiments can be understood and effected by those skilled in the art in practicing the disclosure, from a study of the drawings, the disclosure and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. If a computer program is discussed above, it may be stored/distributed on a suitable medium, such as an optical storage medium or a solid-state medium supplied together with or as part of other hardware, but may also be distributed in other forms, such as via the Internet or other wired or wireless telecommunication systems. If the term “adapted to” is used in the claims or description, it is noted the term “adapted to” is intended to be equivalent to the term “configured to”. Any reference signs in the claims should not be construed as limiting the scope.

1. A device for stimulating a frenulum of male genitalia, the device comprising:
a vibratory part configured to generate vibrations; and
attachment means configured to hold the vibratory part in place against the frenulum during use so as to apply generated vibrations to the frenulum,
wherein the vibratory part comprises first and second vibration means configured to simultaneously generate vibrations of a first and second frequency, respectively,
and wherein the first frequency is different from the second frequency.

2. The device of claim 1, wherein the attachment means comprises a ring that is shaped and sized to receive the male genitalia.

3. The device of claim 1, wherein the attachment means are made from a malleable material which transmits vibrations.

4. The device of claim 1, wherein the attachment means comprise a ring that is shaped and sized to receive the male genitalia.

5. The device of claim 1, wherein the vibratory part comprise a motor, and preferably wherein the motor is configured to generate vibrations of variable frequency or variable amplitude.

6. The device of claim 5, wherein the first vibration means comprise a first gearing arrangement adapted to translate rotation of a rotor of the motor into vibrations of the first frequency, and wherein the second vibration means comprise a second gearing arrangement adapted to translate rotation of the rotor of the motor into vibrations of the second frequency.

7. The device of claim 1, wherein the first vibration means comprise a first motor configured to generate vibrations of the first frequency, wherein the second vibration means comprise a second motor configured to generate vibrations of the second frequency.

8. The device of claim 7, wherein the first vibration means comprise an eccentric weight mounted to a rotatable shaft of the first motor, and wherein the second vibration means comprise an eccentric weight mounted to a rotatable shaft of the second motor.

9. The device of claim 8, wherein the eccentric weight of the first vibration means of larger mass than the eccentric weight of the second vibration means.

10. The device of claim 7, wherein at least one of the first and second motors is configured to generate vibrations of variable frequency.

11. The device claim 1, wherein the attachment means are configured to releasably hold the vibratory part so that the vibratory part is removable from the attachment means.

12. The device of claim 1, further comprising:
a control unit configured to control the vibratory part to adjust the first and second frequency.

13. The device of claim 1, wherein the first vibration means are configured to generate vibrations of a first frequency within a first range of frequencies, wherein the second vibration means are configured to generate vibrations of a second frequency within a second, different range of frequencies.

14. The device of claim 1, wherein the first frequency is within a range of two to seven kilohertz and wherein the second frequency is within a range of two to ninety kilohertz.

15. The device of claim 1, wherein an amplitude of the generated vibrations is up to three millimetres.

16. The device of claim 1, wherein the device is battery operated.

17. A method for stimulating a frenulum of male genitalia, the method comprising:
generating simultaneous vibrations of a first and second frequency with a vibratory part, wherein the first frequency is different from the second frequency; and
holding the vibratory part in place against the frenulum during so as to apply generated vibrations to the frenulum.
